(19) United States
(12) Patent Application Publication
(10) Pub. No.: US 2009/0193455 A1
(43) Pub. Date: Jul. 30, 2009

(54) INFORMATION STORAGE MEDIUM AND METHOD FOR PROVIDING ADDITIONAL CONTENTS BASED ON TRIGGER, AND DIGITAL BROADCAST RECEPTION APPARATUS

(75) Inventors: Sung-wook Ahn, Seoul (KR); Mun-jo Kim, Suwon-si (KR); In-chul Hwang, Suwon-si (KR); O-hoon Kwon, Suwon-si (KR); Eun-hee Rhim, Yongin-si (KR); Sung-jin Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/360,287

(22) Filed: Jan. 27, 2009

Related U.S. Application Data
(60) Provisional application No. 61/024,314, filed on Jan. 29, 2008.

(30) Foreign Application Priority Data
Dec. 19, 2008 (KR) 10-2008-0130445

(51) Int. Cl. H04N 7/025; H04N 7/173

(52) U.S. Cl. 725/32; 725/133

(57) ABSTRACT

Disclosed are an information storage medium having recorded thereon service information regarding a broadcast service to provide additional content, the information storage medium having recorded thereon information for receiving a trigger while the broadcast service is received, information for selecting additional content to be inserted to the broadcast service in correspondence to the received trigger, and a locator for receiving the additional content, a method of providing additional content by using the same, and a digital broadcast reception apparatus.

### CROSS-REFERENCE TO RELATED PATENT APPLICATION

This application claims priority from Korean Patent Application No. 10-2008-0130445, filed on Dec. 19, 2008, in the Korean Intellectual Property Office, and the benefit of U.S. Provisional Patent Application No. 61/024,314, filed on Jan. 29, 2008, in the U.S. Patent and Trademark Office, the disclosures of which are incorporated herein by reference in their entirety.

### BACKGROUND OF THE INVENTION

1. Field of the Invention

The present invention relates to digital broadcasting, and more particularly, to an information storage medium and a method for providing additional contents, such as advertisements, to a user watching digital broadcasting, and a digital broadcast reception apparatus.

2. Description of the Related Art

The fusion of the communication and broadcasting fields has accelerated due to the recent digital convergence resulting in the dramatic popularization of internet protocol television (IPTV) service, which provides digital video service and two-way data service via a high-speed broadband network. Furthermore, digital cable TV services which are based on hybrid filter coaxial (HFC) networks have also contributed to the digitalization of the paid broadcast service market. Service providers providing such digital broadcast services are also interested in additional contents that are to be provided with broadcast programs. Especially, broadcast advertising, which is the fastest and the most precise means of delivering vivid images of a product and/or a service both visually and audibly, is the major source of income to broadcast providers. Therefore, more efficient methods of advertising which use advantages of digital broadcasting are being developed.

### SUMMARY OF THE INVENTION

An aspect of the present invention provides an information storage medium having recorded thereon service information for trigger-based insertion and reproduction of additional content, such as advertising personalized to a user, a method for providing additional contents, and a digital broadcast reception apparatus.

According to an aspect of the present invention, there is provided an information storage medium having recorded thereon service information regarding a broadcast service to provide additional content, the information storage medium having recorded thereon information for receiving a trigger while the broadcast service is received, information for selecting additional content to be inserted to the broadcast service in correspondence to the received trigger, and a locator for receiving the additional content.

The information for receiving the trigger may include a locator of a server transmitting the trigger.

The information for selecting the additional content may include information for identifying insertion of the additional content and information for identifying the additional content.

There may be a plurality of the information for identifying the additional content and a plurality of locators of the additional content.

The information storage medium may have further recorded thereon information instructing termination of insertion of additional content based on the received trigger.

According to another aspect of the present invention, there is provided a method of providing additional content while a broadcast service is received, the method including receiving service information regarding the broadcast service, receiving a trigger, selecting additional content corresponding to the trigger by using the service information, and receiving the selected additional content by using a locator included in the service information and reproducing the received additional content.

The reception of the trigger may include receiving the trigger from a server corresponding to a locator of a trigger transmitting server, the locator included in the service information.

The receiving of the trigger may include filtering trigger information from a transport stream of the broadcast service.

The selection of the additional content may include searching for additional content information corresponding to information for identifying insertion of additional content and information for identifying additional content, the information included in the trigger, in the service information.

The method may further include, if additional content information corresponding to the received trigger instructs to terminate insertion of additional content, restoring the broadcast service.

According to another aspect of the present invention, there is provided a computer readable recording medium having recorded thereon a computer program for executing the method of providing additional content.

According to another aspect of the present invention, there is provided a digital broadcast reception apparatus including a reception unit which receives broadcast service, service information regarding the broadcast service, a trigger, and additional content, a playback unit which reproduces data received via the reception unit, and a control unit which controls the reception unit and the playback unit to select additional content corresponding to the trigger when the trigger is received, to receive the selected additional content by using a locator included in the service information, and to reproduce the received additional content.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of a method of providing additional content according to an exemplary embodiment of the present invention;

FIG. 2 is a flowchart of a method of providing additional content according to another exemplary embodiment of the present invention;

FIG. 3 is a block diagram of a digital broadcast reception apparatus according to another exemplary embodiment of the present invention; and

FIG. 4 illustrates service information written for performing insertion of advertisement according to another exemplary embodiment of the present invention.

### DETAILED DESCRIPTION OF EXEMPLARY EMBODIMENTS OF THE INVENTION

Exemplary embodiments of the present invention will now be described with reference to the attached drawings.

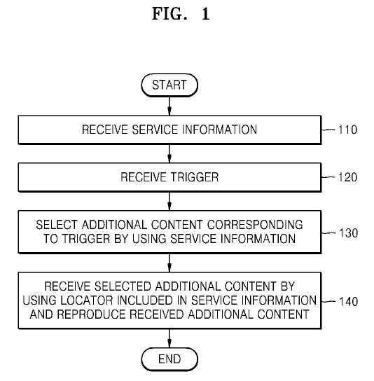

FIG. 1 is a flowchart of a method of providing additional content according to an embodiment of the present invention.

Referring to FIG. 1, service information regarding broadcast service is received while the broadcast service is received (operation 110). The service information is information for identifying broadcast services provided by a plurality of broadcast service providers. Next, a trigger instructing to insert additional content to a currently received broadcast service is received (operation 120). A trigger may be received from a server corresponding to information regarding location of a trigger transmitting server, the information included in service information. However, the method of receiving the trigger is not limited thereto, and, for example, a trigger may be received by filtering a transport stream of a broadcast service and obtaining trigger information therefrom. As soon as a trigger is received, additional content corresponding to the trigger is selected by using service information (operation 130). Service information includes information regarding at least one additional content. Information included in the trigger and information, which is regarding additional content, included in service information are compared to select particular additional content to be switched to and to be reproduced. For example, it is determined whether additional content corresponding to additional content insertion identifying information and additional content identifying information included in the trigger exists or not by verifying service information, and, if the corresponding additional content exists, information required for switching to the additional content, such as a locator, is obtained. By using the obtained locator, the additional content is received and reproduced (operation 140). Accordingly, a broadcast service provider may easily control insertion of trigger-based additional content by using service information regarding broadcast service.

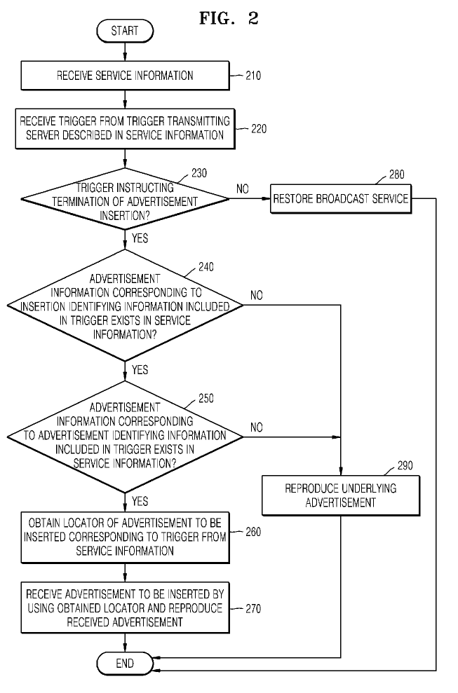

FIG. 2 is a flowchart of a method of providing additional content according to another embodiment of the present invention, illustrating an example in which the present invention is used for inserting advertisements.

Referring to FIG. 2, service information is received while a broadcast service is received (operation 210), and, when a trigger is received from a trigger transmitting server described in the received service information (operation 220), an advertisement is inserted based on trigger information. If the received trigger is a trigger instructing to terminate insertion of advertisement (operation 230), a primary service, which is a broadcast service received prior to the advertisement, is restored (operation 280). It may be determined whether a trigger instructs termination of advertisement insertion or not by verifying whether advertisement information, from among advertisement information included in service information, corresponding to the received trigger instructs termination of advertisement insertion or not.

In case of continuing advertisement insertion (operation 230), it is determined whether or not advertisement insertion identifying information included in trigger information and advertisement information corresponding to the advertisement insertion identifying information exist in service information (operation 240). If corresponding advertisement information exists, it is determined whether or not advertisement information corresponding to advertisement identifying information included in a trigger is included in advertisement information identified by the advertisement insertion identifying information (operation 250). In operations 240 and 250, if no advertisement information corresponding to a trigger exists, that is, if no information regarding an advertisement to be inserted can be found, an underlying advertisement included in a broadcast service is reproduced (operation 290). If advertisement information corresponding to a trigger exists, a locator regarding an advertisement to be inserted is obtained (operation 260), and the advertisement is received by using the locator and is reproduced (operation 270).

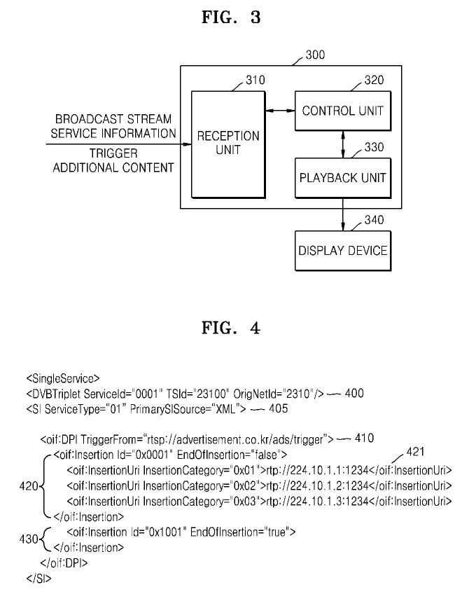

FIG. 3 is a block diagram of a digital broadcast reception apparatus according to another embodiment of the present invention.

Referring to FIG. 3, a digital broadcast reception apparatus 300 includes a reception unit 310 for receiving a broadcast stream for providing a broadcast service, service information regarding the broadcast service, a trigger, and additional content from a server (not shown), a playback unit 330 for reproducing data received via the reception unit 310 and outputting the reproduced data to a display device 340, and a control unit 320 for controlling the reception unit 310 and the playback unit 330 to provide the broadcast service and additional content. A server which manages and transmits a trigger and/or additional content and a broadcast server may be embodied either as the same server or as separate servers.

The control unit 320 selects additional content corresponding to a trigger by using service information as soon as the trigger is received, and controls the reception unit 310 and the playback unit 330 to receive the selected additional content by using a locator included in the service information and to reproduce the received additional content. Furthermore, the control unit 320 controls insertion and reproduction of additional content by performing the methods of providing additional content described above in reference to FIGS. 1 and 2.

FIG. 4 illustrates service information written for performing insertion of an advertisement according to another embodiment of the present invention, wherein the service information is an embodiment of applying the present invention to the service discovery & service selection (SD&S) standard of the digital video broadcast-internet protocol (DVB-IP), which is one of the IPTV standardization organizations.

The SD&S is a technology for identifying a plurality of service information provided by a plurality of service providers at the level of IP. In the context of a home network end device (HNED), service can be received via a plurality of heterogeneous networks. Thus, it is necessary for a HNED to identify service providers and services provided by each of the service providers. Such SD&S information includes information regarding service location and information regarding alternative service, and is transmitted every 30 seconds in the case of being transmitted by a multicasting method. When a HNED is started and SD&S information is received, a reception apparatus is configured based on the SD&S information, and insertion of an advertisement is carried out as described below at a time point for inserting the advertisement.

Referring to FIG. 4, a <oif:DPI> element 410 is added below a <SI> element 405. The <oif:DPI> element 410 includes information 420 and 430 regarding trigger-based advertisements to be inserted, which will be executed in a broadcast service corresponding to <SingleService> element, and real time streaming protocol (RTSP) uniform resource locator (URL) information 410 for receiving extensible markup language (XML) files including trigger information.

An attribute “TriggerFrom” of the <oif:DPI> element 410 includes an URL as its attribute value, and is information for receiving a XML file including trigger information from the URL. If the <oif:DPI> element 410 includes no URL information regarding a trigger, a transport stream of broadcast service may be filtered to obtain trigger information including an advertisement insertion identifier and an advertisement identifier.

The <oif:DPI> element 410 may include <oif:Insertion> elements 420 and 430, which include information regarding advertisements to be inserted. As illustrated in FIG. 4, a plurality of <oif:Insertion> elements may exist. An <oif:Insertion> element has two attributes: “Id” and “EndofInsertion.” The “Id” attribute includes information for identifying insertion of an advertisement as an attribute value, and the “EndofInsertion” attribute includes information for indicating whether to terminate insertion of an advertisement or not as an attribute value. When an advertisement is inserted, an <oif:Insertion> element having an advertisement insertion identifier of a trigger as an “Id” attribute value is selected. An <oif:Insertion> element may include a plurality of <oif:InsertionUri> sub-elements, wherein each of the <oif:InsertionUri> sub-elements may be identified by an attribute value of an “InsertionCategory” attribute and includes a locator of an individual advertisement to be inserted.

If an attribute value of “EndofInsertion” is “false,” it instructs to switch to an advertisement to be inserted. Thus, a locator of a corresponding advertisement is located by searching through <oif:InsertionUri> sub-elements within an <oif:Insertion> element. As a result of the search, URL information in an <oif:InsertionUri> sub-element of which an “InsertionCategory” attribute value corresponds to an advertisement identifier of a trigger XML document is obtained. If an attribute value of “EndofInsertion” is “true,” it instructs to terminate insertion of an advertisement. Thus, a primary service is restored by referring to a <DVBTriplet> element 400 regardless of an <oif:Insertion> element. In this case, an <oif:InsertionUri> sub-element is not necessary in the <oif:Insertion> element 430.

If no <oif:insertion> element is included in an <oif:DPI> element, a underlying advertisement included in the transport stream will be broadcast without inserting an advertisement even if a trigger is received.

Referring to FIG. 4, insertion of an advertisement will be described in closer detail. When a first trigger “trigger1.xml” is received from “rtsp://advertisement.co.kr/ads/trigger” while a broadcast service described in the <DVBTriplet> element 400 is received, an advertisement insertion identifier Id and an advertisement identifier InsertionCategory are obtained by parsing the received file. It is assumed that an “Id” attribute value of the “trigger1.xml” is 0×0001, and an “InsertionCategory” attribute value of the “trigger1.xml” is 0×01. In this case, the <oif:Insertion> element 420 of which an “Id” attribute value is 0×0001 is located, and, since an “EndofInsertion” attribute value of the <oif:Insertion> element 420 is “false,” insertion of an advertisement is carried out. Then, an <oif:InsertionUri> sub-element 421 of which an “InsertionCategory” attribute value is 0×01 is located within the located <oif:Insertion> element 420, and thus an address “rtp://224.10.1.1:1234” is obtained as a locator of an advertisement to be inserted. By using the locator, it is switched from a primary service to the corresponding advertisement as described above.

When broadcasting an inserted advertisement is about to end, a second trigger “trigger2.xml” is received from “rtsp://advertisement.co.kr/ads/trigger” defined by a “TriggerFrom” attribute of the <oif:DPI> element 410. It is assumed that an “Id” attribute value of the “trigger2.xml” is 0×1001. When the second trigger is received, the <oif:Insertion> element 430 of which an “Id” attribute value is 0×1001 is located, and, since an “EndofInsertion” attribute value of this element is “true,” insertion of an advertisement should be terminated. Therefore, a primary service described by the <DVBTriplet> element 400 is restored. Even if an “EndofInsertion” attribute value of the <oif:Insertion> element 430 is “false,” since there is no <oif:InsertionUri> sub-elements exists, a primary service will be restored anyway.

As described above, a broadcast service provider can provide advertisements personalized to each of users by including advertisement information in SD&S. As a result, users may watch advertisements for a longer period of time, and thus advertisement effect may be maximized.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention. The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

What is claimed is:

1. An information storage medium having recorded thereon service information regarding a broadcast service to cause a computer to provide additional content, the information storage medium having recorded thereon:
information for receiving a trigger while the broadcast service is received;
information for selecting additional content to be inserted to the broadcast service in correspondence to the received trigger; and
a locator for receiving the additional content.

2. The information storage medium of claim 1, wherein the information for receiving the trigger comprises a locator of a server transmitting the trigger.

3. The information storage medium of claim 1, wherein the information for selecting the additional content comprises information for identifying insertion of the additional content and information for identifying the additional content.

4. The information storage medium of claim 3, wherein there are a plurality of the information for identifying the additional content and a plurality of locators of the additional content.

5. The information storage medium of claim 1, having further recorded thereon information instructing termination of insertion of additional content based on the received trigger.

6. A method of providing additional content while a broadcast service is received, the method comprising:
receiving, using a receiver, service information regarding the broadcast service;
receiving a trigger;
selecting additional content corresponding to the trigger by using the service information; and
receiving the selected additional content by using a locator included in the service information and reproducing the received additional content.

7. The method of claim 6, wherein the receiving of the trigger comprises receiving the trigger from a server corresponding to a locator of a trigger transmitting server, the locator included in the service information.

8. The method of claim 6, wherein the receiving of the trigger comprises filtering trigger information from a transport stream of the broadcast service.

9. The method of claim 6, wherein the selecting of the additional content comprises searching the service information for additional content information corresponding to information for identifying insertion of additional content and information for identifying additional content, the information included in the trigger.

10. The method of claim 6, further comprising, if additional content information corresponding to the received trigger instructs to terminate insertion of additional content, restoring the broadcast service.

11. The method of claim 6, further comprising, if additional content information corresponding to the received trigger does not exist in the service information, reproducing an underlying additional content included in the broadcast service.

12. A computer readable recording medium having recorded thereon a computer program for causing a computer to execute the method of claim 6.

13. A digital broadcast reception apparatus comprising:
a reception unit which receives broadcast service, service information regarding the broadcast service, a trigger, and additional content;
a playback unit which reproduces data received via the reception unit; and
a control unit which controls the reception unit and the playback unit to select additional content corresponding to the trigger when the trigger is received, to receive the selected additional content by using a locator included in the service information, and to reproduce the received additional content.

14. The digital broadcast reception apparatus of claim 13, wherein the control unit controls the reception unit to receive the trigger from a server corresponding to a locator of a trigger transmitting server, the locator included in the service information.

15. The digital broadcast reception apparatus of claim 13, wherein the control unit controls the reception unit to receive the trigger by filtering trigger information from a transport stream of the broadcast service.

16. The digital broadcast reception apparatus of claim 13, wherein the control unit searches for additional content information corresponding to information for identifying insertion of additional content and information for identifying additional content, the information included in the trigger, in the service information.

17. The digital broadcast reception apparatus of claim 13, wherein, if additional content information corresponding to the received trigger instructs to terminate insertion of additional content, the control unit controls the reception unit and the playback unit to restore the broadcast service.

18. The digital broadcast reception apparatus of claim 13, wherein, if additional content information corresponding to the received trigger does not exist in the service information, the control unit controls the reception unit and the playback unit to reproduce an underlying additional content included in the broadcast service.
